(19) United States
(12) Patent Application Publication
(10) Pub. No.: US 2026/0084591 A1
(43) Pub. Date: Mar. 26, 2026

(54) REVERSIBLE SEAT

(71) Applicant: GM Global Technology Operations LLC, Detroit, MI (US)

(72) Inventors: Pantelis Mouskos, Coburg (AU); Dichuan Pang, Shanghai (CN)

(21) Appl. No.: 18/897,496

(22) Filed: Sep. 26, 2024

(30) Foreign Application Priority Data
Sep. 20, 2024 (CN) 202411323187.9

(51) Int. Cl. B60N 2/22; B60N 2/14

(52) U.S. Cl. CPC B60N 2/2209; B60N 2/143

(57) ABSTRACT

A vehicle seat includes a seat frame, a seatback frame moveably mounted onto the seat frame and selectively moveable between a first seatback frame position and a second seatback frame position, and a seat cushion frame pivotally mounted onto the seat frame wherein the seat cushion frame is pivotally moveable between a first seat cushion position, wherein when the seatback frame is in the first seatback position, the seat cushion is angled toward the seatback frame, and a second seat cushion position, wherein when the seatback frame is in the second seatback position, the seat cushion is angled toward the seatback frame, and wherein, the seat cushion frame is adapted to automatically move from the first seat cushion position to the second seat cushion position as the seatback frame is selectively moved from the first seatback position to the second seatback position.

### INTRODUCTION

The present invention relates generally to a vehicle seat with a reversible seat back. Current vehicles, particularly autonomous vehicles, may include seating arrangements that includes seats that are positioned in rows, wherein all seats face the same direction, or seating arrangements that include seats positioned facing one another. Vehicle seats have carefully designed features to contour to the shape of a passenger for ergonomics and comfort. Seats exist that allow a seat back to be moved from one position where a passenger seated therein faces one way, to a second position, where a passenger faces the opposite direction. However, such seats do not accommodate for angular alignment of the seat cushion relative to the seat back.

Thus, while current reversible seats achieve their intended purpose, there is a need for a new and improved reversible seat that allows a user to selectively move the seat back from a first position, wherein a passenger seated therein faces a first direction to a second position, wherein a passenger seated therein faces a second direction, opposite the first direction, and, wherein, as the seat back is moved from the first position to the second position, angular orientation of a seat cushion relative to the seat back automatically changes.

### SUMMARY

According to several aspects of the present disclosure, a vehicle seat includes a seat frame adapted to be mounted within a vehicle, a seatback frame moveably mounted onto the seat frame wherein the seatback frame is selectively moveable between a first seatback frame position, wherein the seatback frame is positioned adjacent a first side of the seat frame for a passenger seated on the vehicle seat facing a first direction, and a second seatback frame position, wherein the seatback frame is positioned adjacent a second side of the seat frame for a passenger seated on the vehicle seat facing a second direction, opposite the first direction, and a seat cushion frame pivotally mounted onto the seat frame wherein the seat cushion frame is pivotally moveable between a first seat cushion position, wherein when the seatback frame is in the first seatback position, the seat cushion is angled toward the seatback frame, and a second seat cushion position, wherein when the seatback frame is in the second seatback position, the seat cushion is angled toward the seatback frame, and wherein, the seat cushion frame is adapted to automatically move from the first seat cushion position to the second seat cushion position as the seatback frame is selectively moved from the first seatback position to the second seatback position.

According to another aspect, the seatback frame is pivotally moveable relative to the seat frame about a first horizontal axis, and the seat cushion frame is pivotally moveable relative to the seat frame about a second horizontal axis that is parallel to the first horizontal axis.

According to another aspect, the seat frame includes a guide bracket including a plurality of arcuate slots formed therein, the seatback frame supported within a first arcuate slot and a second arcuate slot for translational movement within the first and second arcuate slots between the first seatback frame position and the second seatback frame position.

According to another aspect, the seat cushion frame includes an arcuate guide slot formed therein and a cushion tilt bracket including two horizontal cams spaced from one another, extending horizontally into the arcuate guide slot and adapted to slide within the arcuate guide slot, and the guide bracket includes a third arcuate slot positioned between the first arcuate slot and the second arcuate slot, and a cushion engagement bracket including two horizontal cams spaced from one another, extending horizontally into the third arcuate slot and adapted to slide within the third arcuate slot, the horizontal cams of the cushion engagement bracket engaged with the horizontal cams of the cushion tilt bracket.

According to another aspect, the cushion engagement bracket is moveable within the third arcuate slot of the guide bracket between a first cushion engagement bracket position, wherein the cushion engagement bracket is positioned adjacent the first side of the seat frame and the seat cushion frame is pivoted to the first seat cushion position, and a second cushion engagement bracket position, wherein the cushion engagement bracket is positioned adjacent the second side of the seat frame and the seat cushion frame is pivoted to the second seat cushion position, further wherein, movement of the cushion engagement bracket within the third arcuate slot of the guide bracket from the first cushion engagement bracket position toward the second cushion engagement bracket position moves the cushion tilt bracket within the arcuate guide slot of the seat cushion frame causing the seat cushion frame to pivot about the second horizontal axis from the first seat cushion position toward the second seat cushion position, and movement of the cushion engagement bracket within the third arcuate slot of the guide bracket from the second cushion engagement bracket position toward the first cushion engagement bracket position moves the cushion tilt bracket within the arcuate guide slot of the seat cushion frame causing the seat cushion frame to pivot about the second horizontal axis from the second seat cushion position toward the first seat cushion position.

According to another aspect, when the seatback frame is moved from the first seatback frame position toward the second seatback frame position the seatback frame is adapted to engage the cushion engagement bracket at an intermittent position between the first seatback frame position and the second seatback frame position; wherein upon movement of the seatback frame from the first seatback frame position toward the second seatback frame position, the cushion engagement bracket remains stationary and the seat cushion remains in the first seat cushion position, when the seatback frame reaches the intermittent position, the seatback frame engages the cushion engagement bracket wherein continued movement of the seatback frame toward the second seatback frame position moves the cushion engagement bracket from the first cushion engagement bracket position toward the second cushion engagement bracket position and pivots the seat cushion frame from the first seat cushion position toward the second seat cushion position, and the seatback frame reaches the second seatback frame position, the cushion engagement bracket reaches the second cushion engagement bracket position and the seat cushion frame reaches the second seat cushion position simultaneously.

According to another aspect, when the seatback frame is moved from the second seatback frame position toward the first seatback frame position the seatback frame is adapted to engage the cushion engagement bracket at the intermittent position between the first seatback frame position and the second seatback frame position; wherein upon movement of the seatback frame from the second seatback frame position toward the first seatback frame position, the cushion engagement bracket remains stationary and the seat cushion remains in the second seat cushion position, when the seatback frame reaches the intermittent position, the seatback frame engages the cushion engagement bracket wherein continued movement of the seatback frame toward the first seatback frame position moves the cushion engagement bracket from the second cushion engagement bracket position toward the first cushion engagement bracket position and pivots the seat cushion frame from the second seat cushion position toward the first seat cushion position, and the seatback frame reaches the first seatback frame position, the cushion engagement bracket reaches the first cushion engagement bracket position and the seat cushion frame reaches the first seat cushion position simultaneously.

According to another aspect, when the seatback frame is moved from the first seatback frame position toward the second seatback frame position the seatback frame is adapted to engage a first one of the two horizontal cams extending horizontally into the third arcuate slot within the guide bracket, and when the seatback frame is moved from the second seatback frame position toward the first seatback frame position the seatback frame is adapted to engage a second one of the two horizontal cams extending horizontally into the third arcuate slot within the guide bracket.

According to another aspect, the vehicle seat further includes a latch mechanism mounted onto the seatback frame adapted to secure the seatback frame within one of the first or second seatback frame positions, and adapted to allow a user to selectively disengage the latch mechanism to move the seatback frame back and forth between the first and second seatback frame positions.

According to another aspect, the seat frame includes floor tracks, wherein, when the vehicle seat is mounted within a vehicle, the seat frame is slidable horizontally along the floor tracks.

According to another aspect, the first, second and third arcuate slots formed within the guide bracket are parallel to one another and oriented with an arch shape, and the arcuate guide slot formed within the seat cushion frame is oriented with an inverted arch shape.

According to another aspect, the seat frame includes a first end and a second end, the seat cushion frame includes a first end and a second end, and the seatback frame includes a first leg and a second leg, wherein the first leg of the seatback frame engages a first guide bracket positioned at the first end of the seat frame and the second leg of the seatback frame engages a second guide bracket positioned at the second end of the seat frame.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle according to an exemplary embodiment of the present disclosure;

FIG. 2A is a side view of a vehicle seat according to the present disclosure wherein the seat back is in a first position;

FIG. 2B is a side view of the vehicle seat of FIG. 2A wherein the seat back is in a second position;

FIG. 3 is a schematic view of a seat frame of the vehicle seat shown in FIG. 2A and FIG. 2B;

FIG. 4 is an enlarged view of a portion of FIG. 3, as indicated by the area labeled “FIG. 4” in FIG. 3;

FIG. 5 is an enlarged view of a portion of FIG. 3, as indicated by the area labeled “FIG. 5” in FIG. 3;

FIG. 6A is schematic perspective view of the seat frame wherein the seatback frame is in a first seatback frame position;

FIG. 6B is a schematic perspective view of the seat frame wherein the seatback frame is positioned at an intermittent position between the first seatback frame position and the second seatback frame position;

FIG. 6C is a schematic perspective view of the seat frame wherein the seatback frame moves from the intermittent position toward the second seatback frame position and the seat cushion frame moves from a first seat cushion position toward a second seat cushion position; and

FIG. 6D is a schematic perspective view of the seat frame wherein the seatback frame is positioned at the second seat back frame position and the seat cushion frame is positioned at the second seat cushion position.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

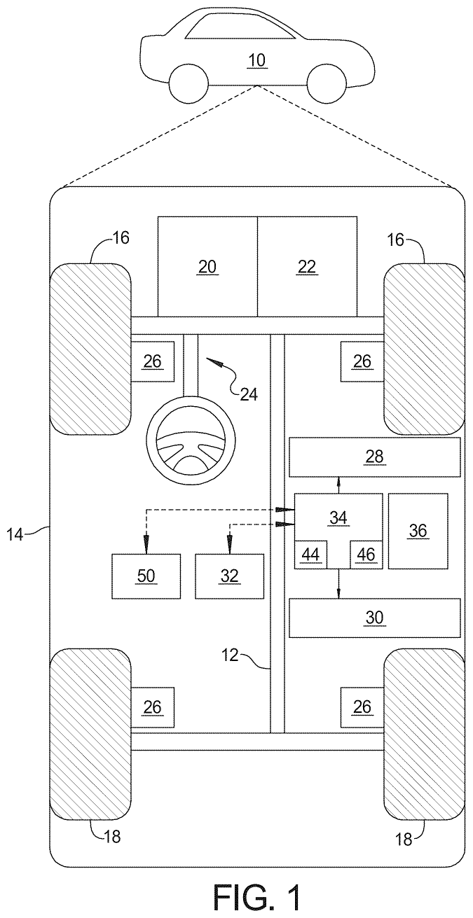

Example embodiments will now be described more fully with reference to the accompanying drawings. In accordance with an exemplary embodiment, FIG. 1 shows a vehicle 10 with an associated vehicle seat 50. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 11 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the vehicle controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

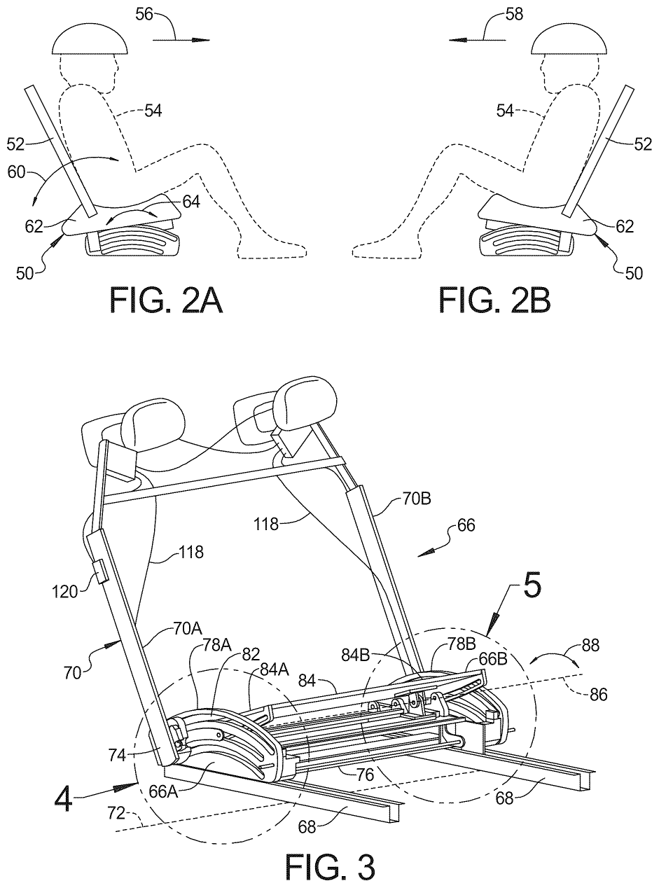

Referring to FIG. 2A and FIG. 2B, a vehicle seat 50 in accordance with novel features of the present disclosure allows a user to selectively move a seat back 52 between a first position and a second position. Referring to FIG. 2A, when the seat back 52 is in the first position a passenger 54 seated therein faces a first direction, as indicated by arrow 56. Referring to FIG. 2B, when the seat back 52 is in the second position a passenger 54 seated therein faces a second direction, opposite the first direction, as indicated by arrow 58. The seat back 52 is adapted to move between the first position and the second position as indicated by arrow 60. As the seat back 52 is moved between the first position and the second position, angular orientation of a seat cushion 62 relative to a frame of the vehicle seat 50 automatically changes, as indicated by arrow 64. As shown in FIG. 2A, when the seat back 52 is in the first position, the seat cushion is angled toward the seat back 52. When a user selectively moves the seat back 52 from the first position to the second position, the seat cushion 62 automatically and simultaneously changes angular position. As shown in FIG. 2B, when the seat back is moved to the second position, the seat cushion 62 automatically changes angular orientation and is angled toward the seat back 52.

Referring to FIG. 3, in an exemplary embodiment, the vehicle seat 50 includes a seat frame 66 that is adapted to be mounted within a vehicle 10. As shown, the seat frame 66 includes floor tracks 68 attached to the seat frame 66, wherein, when the vehicle seat 50 is mounted within a vehicle 10, the seat frame 66 is slidable horizontally along the floor tracks 68, allowing a user to adjust the horizontal position of the vehicle seat 50 within the vehicle 10.

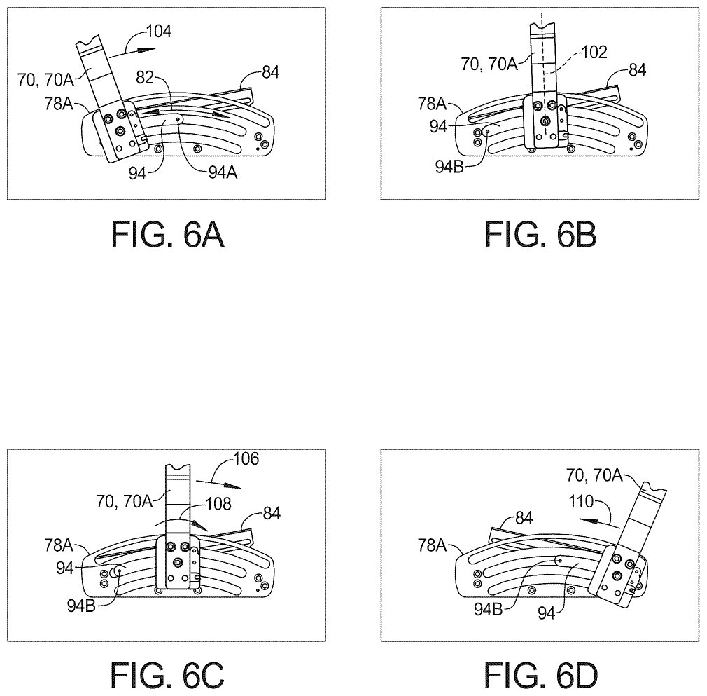

A seatback frame 70 adapted to support the seat back 52 is moveably mounted onto the seat frame 66. The seatback frame 70 is selectively and pivotally moveable relative to the seat frame 66 about a first horizontal axis 72. The seatback frame 70 is moveable between a first seatback frame position and a second seatback frame position. In the first seatback frame position, the seatback frame 70 is positioned adjacent a first side 74 of the seat frame 66 for a passenger seated on the vehicle seat 50 facing the first direction (arrow 56 in FIG. 2A), as shown in FIG. 2A, FIG. 3 and FIG. 6A. In the second seatback frame position, the seatback frame 70 is positioned adjacent a second side 76 of the seat frame 66 for a passenger seated on the vehicle seat 50 facing the second direction (arrow 58 in FIG. 2B), as shown in FIG. 2B and FIG. 6D.

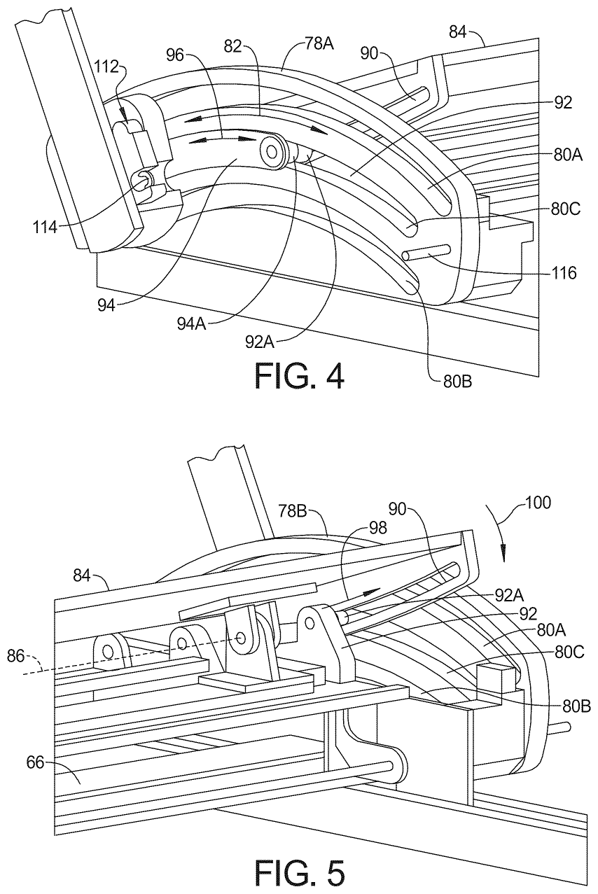

Referring to FIG. 3 and FIG. 4, a guide bracket 78A is mounted onto the seat frame 66 and includes a plurality of parallel arcuate slots 80A, 80B, 80C oriented in an upward arch shape formed therein. The seatback frame 70 is supported within a first arcuate slot 80A and a second arcuate slot 80B for translational movement, as indicated by arrow 82, within the first and second arcuate slots 80A, 80B between the first seatback frame position, as shown in FIG. 3, FIG. 4 and FIG. 6A, and the second seatback frame position, as shown in FIG. 6D.

A seat cushion frame 84 adapted to support the seat cushion 62 thereon is pivotally mounted onto the seat frame 66, wherein the seat cushion frame 84 is pivotally moveable about a second horizontal axis 86, that is parallel to the first horizontal axis 72, as indicated by arrow 88. The seat cushion frame 84 is pivotally moveable between a first seat cushion position and a second seat cushion position. When the seatback frame 70 is in the first seatback position, the seat cushion frame 84 is in the first seat cushion position and is angled toward the seatback frame 70, as shown in FIG. 3 and FIG. 6A, and when the seatback frame 70 is in the second seatback position, the seat cushion frame 84 is in the second seat cushion position and is angled toward the seatback frame 70, as shown in FIG. 6D.

As shown, the seat frame 66 includes a first end 66A and a second end 66B, the seat cushion frame 84 includes a first end 84A and a second end 84B, and the seatback frame 70 includes a first leg 70A and a second leg 70B. The first leg 70A of the seatback frame 70 engages a first guide bracket 78A positioned at the first end 66A of the seat frame 66 and the second leg 70B of the seatback frame 70 engages a second guide bracket 78B positioned at the second end 66B of the seat frame 66. The first end 66A of the seat frame 66 and the second end 66B of the seat frame 66 are mirror images of each other, including identical components. For purposes of description herein, the components of each end 66A, 66B of the seat frame 66 will be described singularly.

Referring to FIG. 4 and FIG. 5, the seat cushion frame 84 includes an arcuate guide slot 90 having an inverted arch shape formed therein. A cushion tilt bracket 92 includes two horizontal cams 92A, 92B spaced from one another and extending horizontally into the arcuate guide slot 90 and adapted to slide within the arcuate guide slot 90. A cushion engagement bracket 94 includes two horizontal cams 94A, 94B spaced from one another, extending horizontally into and adapted to slide within a third arcuate slot 80C formed within the guide bracket 78A and positioned between the first and second arcuate slots 80A, 80B. The first, second and third arcuate slots 80A, 80B, 80C formed within the guide bracket 78A are parallel to one another and oriented with an arch shape. The horizontal cams 94A, 94B of the cushion engagement bracket 94 are engaged with the horizontal cams 92A, 92B of the cushion tilt bracket 92, such that the cushion engagement bracket 94 and the cushion tilt bracket 92 move in unison. Movement of the cushion engagement bracket 94 within the third arcuate slot 80C of the guide bracket 78A moves the cushion tilt bracket 92 within the arcuate guide slot 90. Movement of the cushion tilt bracket 92 within the arcuate guide slot 90 causes the seat chusion frame 84 to pivot about the second horizontal axis 86. Thus, the seat cushion frame 84 is adapted to automatically move from the first seat cushion position to the second seat cushion position as the seatback frame is selectively moved from the first seatback position to the second seatback position. Correspondingly, the seat cushion frame 84 is adapted to automatically move from the second seat cushion position to the first seat cushion position as the seatback frame is selectively moved from the second seatback position to the first seatback position.

The cushion engagement bracket 94 is moveable within the third arcuate slot 80C of the guide bracket 78A between a first cushion engagement bracket position and a second cushion engagement bracket position. When the cushion engagement bracket 94 is in the first cushion engagement bracket position, the cushion engagement bracket 94 is positioned adjacent the first side 74 of the seat frame 66 and the seat cushion frame 84 is pivoted to the first seat cushion position, as shown in FIG. 3, FIG. 4 and FIG. 6A. When the cushion engagement bracket 94 is in the second cushion engagement bracket position, the cushion engagement bracket 94 is positioned adjacent the second side 76 of the seat frame 66 and the seat cushion frame 84 is pivoted to the second seat cushion position, as shown in FIG. 6D.

Movement of the cushion engagement bracket 94 within the third arcuate slot 80C of the guide bracket 78A from the first cushion engagement bracket position toward the second cushion engagement bracket position, as indicated by arrow 96 in FIG. 4, moves the cushion tilt bracket 92 within the arcuate guide slot 90 of the seat cushion frame 84, as indicated by arrow 98 in FIG. 5, causing the seat cushion frame 84 to pivot about the second horizontal axis 86 from the first seat cushion position toward the second seat cushion position, as indicated by arrow 100 in FIG. 5. Correspondingly, movement of the cushion engagement bracket 94 within the third arcuate slot 80C of the guide bracket 78A from the second cushion engagement bracket position toward the first cushion engagement bracket position moves the cushion tilt bracket 92 within the arcuate guide slot 90 of the seat cushion frame 84 causing the seat cushion frame 84 to pivot about the second horizontal axis 86 from the second seat cushion position toward the first seat cushion position.

In an exemplary embodiment, when the seatback frame 70 is moved from the first seatback frame position toward the second seatback frame position the seatback frame 70 is adapted to engage the cushion engagement bracket 94 at an intermittent position 102 between the first seatback frame position and the second seatback frame position, and when the seatback frame 70 is moved from the second seatback frame position toward the first seatback frame position the seatback frame is adapted to engage the cushion engagement bracket at the intermittent position 102 between the first seatback frame position and the second seatback frame position.

Referring to FIG. 6A, upon movement of the seatback frame 70 from the first seatback frame position toward the second seatback frame position, as indicated by arrow 104, the cushion engagement bracket 94 remains stationary and the seat cushion frame 84 remains in the first seat cushion position. Referring to FIG. 6B, when the seatback frame 70 reaches the intermittent position 102, roughly half-way between the first seatback frame position and the second seatback frame position, the seatback frame 70 engages the cushion engagement bracket 94. Referring to FIG. 6C, continued movement of the seatback frame 70 toward the second seatback frame position, as indicated by arrow 106, moves the cushion engagement bracket 94 from the first cushion engagement bracket position toward the second cushion engagement bracket position and pivots the seat cushion frame 84 from the first seat cushion position toward the second seat cushion position, as indicated by arrow 108. Referring to FIG. 6D, the seatback frame 70 reaches the second seatback frame position, the cushion engagement bracket 94 reaches the second cushion engagement bracket position and the seat cushion frame 84 reaches the second seat cushion position simultaneously.

Correspondingly, upon movement of the seatback frame 70 from the second seatback frame position toward the first seatback frame position, as indicated by arrow 110 in FIG. 6D, the cushion engagement bracket 94 remains stationary and the seat cushion frame 84 remains in the second seat cushion position. When the seatback frame 70 reaches the intermittent position 102, the seatback frame 70 once again engages the cushion engagement bracket 94, wherein continued movement of the seatback frame 70 toward the first seatback frame position moves the cushion engagement bracket 94 from the second cushion engagement bracket position toward the first cushion engagement bracket position and pivots the seat cushion frame 84 from the second seat cushion position toward the first seat cushion position. The seatback frame 70 reaches the first seatback frame position, the cushion engagement bracket 94 reaches the first cushion engagement bracket position and the seat cushion frame 84 reaches the first seat cushion position simultaneously.

Referring to FIG. 6A, in an exemplary embodiment, when the seatback frame 70 is moved from the first seatback frame position toward the second seatback frame position, as indicated by arrow 104, the seatback frame is adapted to engage a first one 94A of the two horizontal cams 94A, 94B of the cushion engagement bracket 94 extending horizontally into the third arcuate slot 80C within the guide bracket 78A at the intermittent position 102, after which, the seatback frame 70 moves in unison with the cushion engagement bracket 94 and the seat cushion frame 84. Referring to FIG. 6D, when the seatback frame 70 is moved from the second seatback frame position toward the first seatback frame position, as indicated by arrow 110, the seatback frame 70 is adapted to engage a second one 94B of the two horizontal cams 94A, 94B of the cushion engagement bracket 94 extending horizontally into the third arcuate slot 80C within the guide bracket 78A at the intermittent position 102, after which, the seatback frame 70 moves in unison with the cushion engagement bracket 94 and the seat cushion frame 84.

In an exemplary embodiment the vehicle seat 50 includes a latch mechanism 112 mounted onto the seatback frame 70 adapted to secure the seatback frame 70 within one of the first or second seatback frame positions. The latch mechanism 112 is adapted to allow a user to selectively disengage the latch mechanism 112 to move the seatback frame 70 back and forth between the first and second seatback frame positions. As shown, the latch mechanism 70 includes a latch 114 adapted to engage a latch pin 116. As shown in FIG. 3, the latch 114 is positioned on a side of the seatback frame 70 and is adapted to engage the latch pin 116 located adjacent the second side 76 of the seat frame 66 to secure the seatback frame 70 in the second seatback frame position. Not visible in the figures, the latch mechanism 112 includes a second latch located on the opposite side of the seatback frame 70 and adapted to engage a second latch pin positioned adjacent the first side 74 of the seat frame 66 to secure the seatback frame 70 in the first seatback frame position.

As shown, the seat frame 66 includes a latch mechanism on each one of the first and second legs 70A, 70B of the seatback frame 70. Further, the vehicle seat 50 includes actuator cables 118 extending from the latch mechanisms 112 to allow a user to selectively disengage the latch mechanisms 112 and allow movement of the seatback frame 70 back and forth between the first and second seatback frame positions. In another exemplary embodiment, as shown in FIG. 3, the vehicle seat 50 includes an additional latch mechanism 120 located at an alternate location of the seatback frame 70 to allow the seatback frame 70 to be secured to other structural components within the vehicle 10.

A vehicle seat 50 of the present disclosure offers several advantages. These include allowing the vehicle seat 50 to be converted from facing a first direction to facing a second direction. For example, the first seatback frame position may allow a passenger seated therein to face forward in a vehicle so the passenger can see forward, such as for driving the vehicle. Alternatively, the second seatback frame position allows a passenger seated therein to face rearward, allowing a campfire like seating arrangement where a passenger in a front row faces passengers in a rear row. This may be particularly useful when a user wishes to face rearward while the vehicle is stationary, or in the case of fully autonomous vehicles, the front row passengers, including the passenger seated in the traditional “drivers” seat can face rearward as the vehicle travels autonomously.

Further, traditional seats that provide for moveable seatbacks are limited to using a substantially flat seat cushion that is suitable for a passenger facing either direction. The vehicle seat of the present disclosure provides for automatic adjustment of an angular orientation of the seat cushion 62 when the seatback 52 is moved between the first seatback frame position and the second seatback frame position. This provides for ergonomic angular orientation of the seat cushion 62 when the seatback frame 70 is in either the first seatback frame position or the second seatback frame position.

Finally, the movement of the seatback frame 70 within the guide bracket 78A and engagement of the cushion engagement bracket 94 with the cushion tilt bracket 92, facilitate smooth simultaneous automatic movement of the seat cushion frame 84 from the first seat cushion position to the second seat cushion position when the seatback frame 70 is moved from the first seatback frame position to the second seatback frame position, and smooth simultaneous automatic movement of the seat cushion frame 84 from the second seat cushion position to the first seat cushion position when the seatback frame 70 is moved from the second seatback frame position to the first seatback frame position.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A vehicle seat, comprising:
a seat frame adapted to be mounted within a vehicle;
a seatback frame moveably mounted onto the seat frame wherein the seatback frame is selectively moveable between:
a first seatback frame position, wherein the seatback frame is positioned adjacent a first side of the seat frame for a passenger seated on the vehicle seat facing a first direction; and
a second seatback frame position, wherein the seatback frame is positioned adjacent a second side of the seat frame for a passenger seated on the vehicle seat facing a second direction, opposite the first direction; and
a seat cushion frame pivotally mounted onto the seat frame wherein the seat cushion frame is pivotally moveable between:
a first seat cushion position, wherein when the seatback frame is in the first seatback position, the seat cushion is angled toward the seatback frame; and
a second seat cushion position, wherein when the seatback frame is in the second seatback position, the seat cushion is angled toward the seatback frame; and
wherein, the seat cushion frame is adapted to automatically move from the first seat cushion position to the second seat cushion position as the seatback frame is selectively moved from the first seatback position to the second seatback position.

2. The vehicle seat of claim 1, wherein the seatback frame is pivotally moveable relative to the seat frame about a first horizontal axis, and the seat cushion frame is pivotally moveable relative to the seat frame about a second horizontal axis that is parallel to the first horizontal axis.

3. The vehicle seat of claim 2, wherein the seat frame includes a guide bracket including a plurality of arcuate slots formed therein, the seatback frame supported within a first arcuate slot and a second arcuate slot for translational movement within the first and second arcuate slots between the first seatback frame position and the second seatback frame position.

4. The vehicle seat of claim 3, wherein:
the seat cushion frame includes an arcuate guide slot formed therein and a cushion tilt bracket including two horizontal cams spaced from one another, extending horizontally into the arcuate guide slot and adapted to slide within the arcuate guide slot; and
the guide bracket includes a third arcuate slot positioned between the first arcuate slot and the second arcuate slot, and a cushion engagement bracket including two horizontal cams spaced from one another, extending horizontally into the third arcuate slot and adapted to slide within the third arcuate slot, the horizontal cams of the cushion engagement bracket engaged with the horizontal cams of the cushion tilt bracket.

5. The vehicle seat of claim 4, wherein the cushion engagement bracket is moveable within the third arcuate slot of the guide bracket between:
a first cushion engagement bracket position, wherein the cushion engagement bracket is positioned adjacent the first side of the seat frame and the seat cushion frame is pivoted to the first seat cushion position; and
a second cushion engagement bracket position, wherein the cushion engagement bracket is positioned adjacent the second side of the seat frame and the seat cushion frame is pivoted to the second seat cushion position;
further wherein:
movement of the cushion engagement bracket within the third arcuate slot of the guide bracket from the first cushion engagement bracket position toward the second cushion engagement bracket position moves the cushion tilt bracket within the arcuate guide slot of the seat cushion frame causing the seat cushion frame to pivot about the second horizontal axis from the first seat cushion position toward the second seat cushion position; and
movement of the cushion engagement bracket within the third arcuate slot of the guide bracket from the second cushion engagement bracket position toward the first cushion engagement bracket position moves the cushion tilt bracket within the arcuate guide slot of the seat cushion frame causing the seat cushion frame to pivot about the second horizontal axis from the second seat cushion position toward the first seat cushion position.

6. The vehicle seat of claim 5, wherein when the seatback frame is moved from the first seatback frame position toward the second seatback frame position the seatback frame is adapted to engage the cushion engagement bracket at an intermittent position between the first seatback frame position and the second seatback frame position; wherein:
upon movement of the seatback frame from the first seatback frame position toward the second seatback frame position, the cushion engagement bracket remains stationary and the seat cushion remains in the first seat cushion position;
when the seatback frame reaches the intermittent position, the seatback frame engages the cushion engagement bracket wherein continued movement of the seatback frame toward the second seatback frame position moves the cushion engagement bracket from the first cushion engagement bracket position toward the second cushion engagement bracket position and pivots the seat cushion frame from the first seat cushion position toward the second seat cushion position; and
the seatback frame reaches the second seatback frame position, the cushion engagement bracket reaches the second cushion engagement bracket position and the seat cushion frame reaches the second seat cushion position simultaneously.

7. The vehicle seat of claim 6, wherein when the seatback frame is moved from the second seatback frame position toward the first seatback frame position the seatback frame is adapted to engage the cushion engagement bracket at the intermittent position between the first seatback frame position and the second seatback frame position; wherein:
upon movement of the seatback frame from the second seatback frame position toward the first seatback frame position, the cushion engagement bracket remains stationary and the seat cushion remains in the second seat cushion position;
when the seatback frame reaches the intermittent position, the seatback frame engages the cushion engagement bracket wherein continued movement of the seatback frame toward the first seatback frame position moves the cushion engagement bracket from the second cushion engagement bracket position toward the first cushion engagement bracket position and pivots the seat cushion frame from the second seat cushion position toward the first seat cushion position; and
the seatback frame reaches the first seatback frame position, the cushion engagement bracket reaches the first cushion engagement bracket position and the seat cushion frame reaches the first seat cushion position simultaneously.

8. The vehicle seat of claim 7, wherein when the seatback frame is moved from the first seatback frame position toward the second seatback frame position the seatback frame is adapted to engage a first one of the two horizontal cams extending horizontally into the third arcuate slot within the guide bracket, and when the seatback frame is moved from the second seatback frame position toward the first seatback frame position the seatback frame is adapted to engage a second one of the two horizontal cams extending horizontally into the third arcuate slot within the guide bracket.

9. The vehicle seat of claim 8 further including a latch mechanism mounted onto the seatback frame adapted to secure the seatback frame within one of the first or second seatback frame positions, and adapted to allow a user to selectively disengage the latch mechanism to move the seatback frame back and forth between the first and second seatback frame positions.

10. The vehicle seat of claim 9, wherein the seat frame includes floor tracks, wherein, when the vehicle seat is mounted within a vehicle, the seat frame is slidable horizontally along the floor tracks.

11. The vehicle seat of claim 10, wherein the first, second and third arcuate slots formed within the guide bracket are parallel to one another and oriented with an arch shape, and the arcuate guide slot formed within the seat cushion frame is oriented with an inverted arch shape.

12. The vehicle seat of claim 11, wherein the seat frame includes a first end and a second end, the seat cushion frame includes a first end and a second end, and the seatback frame includes a first leg and a second leg, wherein the first leg of the seatback frame engages a first guide bracket positioned at the first end of the seat frame and the second leg of the seatback frame engages a second guide bracket positioned at the second end of the seat frame.

13. A vehicle seat, comprising:
a seat frame adapted to be mounted within a vehicle;
a seatback frame moveably mounted onto the seat frame wherein the seatback frame is selectively and pivotally moveable relative to the seat frame about a first horizontal axis between:
a first seatback frame position, wherein the seatback frame is positioned adjacent a first side of the seat frame for a passenger seated on the vehicle seat facing a first direction; and
a second seatback frame position, wherein the seatback frame is positioned adjacent a second side of the seat frame for a passenger seated on the vehicle seat facing a second direction, opposite the first direction;
a guide bracket mounted onto the seat frame and including a plurality of parallel arcuate slots oriented in an upward arch shape formed therein, the seatback frame supported within a first arcuate slot and a second arcuate slot for translational movement within the first and second arcuate slots between the first seatback frame position and the second seatback frame position; and
a seat cushion frame pivotally mounted onto the seat frame wherein the seat cushion frame is pivotally moveable about a second horizontal axis, that is parallel to the first horizontal axis, between:
a first seat cushion position, wherein when the seatback frame is in the first seatback position, the seat cushion is angled toward the seatback frame; and
a second seat cushion position, wherein when the seatback frame is in the second seatback position, the seat cushion is angled toward the seatback frame; and
an arcuate guide slot having an inverted arch shape formed within the seat cushion frame;
a cushion tilt bracket including two horizontal cams spaced from one another, extending horizontally into the arcuate guide slot and adapted to slide within the arcuate guide slot; and
a cushion engagement bracket including two horizontal cams spaced from one another, extending horizontally into and adapted to slide within a third arcuate slot formed within the guide bracket and positioned between the first and second arcuate slots; and
wherein the horizontal cams of the cushion engagement bracket are engaged with the horizontal cams of the cushion tilt bracket and the seat cushion frame is adapted to automatically move from the first seat cushion position to the second seat cushion position as the seatback frame is selectively moved from the first seatback position to the second seatback position.

14. The vehicle seat of claim 13, wherein the cushion engagement bracket is moveable within the third arcuate slot of the guide bracket between:
a first cushion engagement bracket position, wherein the cushion engagement bracket is positioned adjacent the first side of the seat frame and the seat cushion frame is pivoted to the first seat cushion position; and
a second cushion engagement bracket position, wherein the cushion engagement bracket is positioned adjacent the second side of the seat frame and the seat cushion frame is pivoted to the second seat cushion position;
further wherein:
movement of the cushion engagement bracket within the third arcuate slot of the guide bracket from the first cushion engagement bracket position toward the second cushion engagement bracket position moves the cushion tilt bracket within the arcuate guide slot of the seat cushion frame causing the seat cushion frame to pivot about the second horizontal axis from the first seat cushion position toward the second seat cushion position; and
movement of the cushion engagement bracket within the third arcuate slot of the guide bracket from the second cushion engagement bracket position toward the first cushion engagement bracket position moves the cushion tilt bracket within the arcuate guide slot of the seat cushion frame causing the seat cushion frame to pivot about the second horizontal axis from the second seat cushion position toward the first seat cushion position.

15. The vehicle seat of claim 14, wherein when the seatback frame is moved from the first seatback frame position toward the second seatback frame position the seatback frame is adapted to engage the cushion engagement bracket at an intermittent position between the first seatback frame position and the second seatback frame position, and when the seatback frame is moved from the second seatback frame position toward the first seatback frame position the seatback frame is adapted to engage the cushion engagement bracket at the intermittent position between the first seatback frame position and the second seatback frame position, wherein:
upon movement of the seatback frame from the first seatback frame position toward the second seatback frame position, the cushion engagement bracket remains stationary and the seat cushion remains in the first seat cushion position, and when the seatback frame reaches the intermittent position, the seatback frame engages the cushion engagement bracket wherein continued movement of the seatback frame toward the second seatback frame position moves the cushion engagement bracket from the first cushion engagement bracket position toward the second cushion engagement bracket position and pivots the seat cushion frame from the first seat cushion position toward the second seat cushion position, and the seatback frame reaches the second seatback frame position, the cushion engagement bracket reaches the second cushion engagement bracket position and the seat cushion frame reaches the second seat cushion position simultaneously; and
upon movement of the seatback frame from the second seatback frame position toward the first seatback frame position, the cushion engagement bracket remains stationary and the seat cushion remains in the second seat cushion position, and when the seatback frame reaches the intermittent position, the seatback frame engages the cushion engagement bracket wherein continued movement of the seatback frame toward the first seatback frame position moves the cushion engagement bracket from the second cushion engagement bracket position toward the first cushion engagement bracket position and pivots the seat cushion frame from the second seat cushion position toward the first seat cushion position, and the seatback frame reaches the first seatback frame position, the cushion engagement bracket reaches the first cushion engagement bracket position and the seat cushion frame reaches the first seat cushion position simultaneously.

16. The vehicle seat of claim 15, wherein when the seatback frame is moved from the first seatback frame position toward the second seatback frame position the seatback frame is adapted to engage a first one of the two horizontal cams extending horizontally into the third arcuate slot within the guide bracket, and when the seatback frame is moved from the second seatback frame position toward the first seatback frame position the seatback frame is adapted to engage a second one of the two horizontal cams extending horizontally into the third arcuate slot within the guide bracket.

17. The vehicle seat of claim 16 further including:
a latch mechanism mounted onto the seatback frame adapted to secure the seatback frame within one of the first or second seatback frame positions, and adapted to allow a user to selectively disengage the latch mechanism to move the seatback frame back and forth between the first and second seatback frame positions; and
floor tracks attached to the seat frame, wherein, when the vehicle seat is mounted within a vehicle, the seat frame is slidable horizontally along the floor tracks.

18. The vehicle seat of claim 17, wherein the first, second and third arcuate slots formed within the guide bracket are parallel to one another and oriented with an arch shape, and the arcuate guide slot formed within the seat cushion frame is oriented with an inverted arch shape.

19. The vehicle seat of claim 18, wherein the seat frame includes a first end and a second end, the seat cushion frame includes a first end and a second end, and the seatback frame includes a first leg and a second leg, wherein the first leg of the seatback frame engages a first guide bracket positioned at the first end of the seat frame and the second leg of the seatback frame engages a second guide bracket positioned at the second end of the seat frame.

20. A vehicle having a vehicle seat, the vehicle seat comprising:
a seat frame adapted to be mounted within a vehicle;
a seatback frame moveably mounted onto the seat frame wherein the seatback frame is selectively and pivotally moveable relative to the seat frame about a first horizontal axis between:
a first seatback frame position, wherein the seatback frame is positioned adjacent a first side of the seat frame for a passenger seated on the vehicle seat facing a first direction; and
a second seatback frame position, wherein the seatback frame is positioned adjacent a second side of the seat frame for a passenger seated on the vehicle seat facing a second direction, opposite the first direction;
a guide bracket mounted onto the seat frame and including a plurality of parallel arcuate slots oriented in an upward arch shape formed therein, the seatback frame supported within a first arcuate slot and a second arcuate slot for translational movement within the first and second arcuate slots between the first seatback frame position and the second seatback frame position; and
a seat cushion frame pivotally mounted onto the seat frame wherein the seat cushion frame is pivotally moveable about a second horizontal axis, that is parallel to the first horizontal axis, between:
a first seat cushion position, wherein when the seatback frame is in the first seatback position, the seat cushion is angled toward the seatback frame; and
a second seat cushion position, wherein when the seatback frame is in the second seatback position, the seat cushion is angled toward the seatback frame; and
an arcuate guide slot having an inverted arch shape formed within the seat cushion frame;
a cushion tilt bracket including two horizontal cams spaced from one another, extending horizontally into the arcuate guide slot and adapted to slide within the arcuate guide slot; and
a cushion engagement bracket including two horizontal cams spaced from one another, extending horizontally into and adapted to slide within a third arcuate slot formed within the guide bracket and positioned between the first and second arcuate slots, the cushion engagement bracket moveable within the third arcuate slot of the guide bracket between:
a first cushion engagement bracket position, wherein the cushion engagement bracket is positioned adjacent the first side of the seat frame and the seat cushion frame is pivoted to the first seat cushion position; and
a second cushion engagement bracket position, wherein the cushion engagement bracket is positioned adjacent the second side of the seat frame and the seat cushion frame is pivoted to the second seat cushion position; and
the horizontal cams of the cushion engagement bracket engaged with the horizontal cams of the cushion tilt bracket, wherein:
movement of the cushion engagement bracket within the third arcuate slot of the guide bracket from the first cushion engagement bracket position toward the second cushion engagement bracket position moves the cushion tilt bracket within the arcuate guide slot of the seat cushion frame causing the seat cushion frame to pivot about the second horizontal axis from the first seat cushion position toward the second seat cushion position;
movement of the cushion engagement bracket within the third arcuate slot of the guide bracket from the second cushion engagement bracket position toward the first cushion engagement bracket position moves the cushion tilt bracket within the arcuate guide slot of the seat cushion frame causing the seat cushion frame to pivot about the second horizontal axis from the second seat cushion position toward the first seat cushion position; and
the seat cushion frame automatically moves from the first seat cushion position to the second seat cushion position as the seatback frame is selectively moved from the first seatback position to the second seatback position, and the seat cushion frame automatically moves from the second seat cushion position to the first seat cushion position as the seatback frame is selectively moved from the second seatback position to the first seatback position.
